(19) United States
(12) Patent Application Publication
(10) Pub. No.: US 2013/0159400 A1
(43) Pub. Date: Jun. 20, 2013

(54) USER DEVICE, SERVER, AND OPERATING CONDITIONS SETTING SYSTEM

(71) Applicants: Bunichiro Fujii, Chiba (JP); Hiroshi Okada, Kanagawa (JP); Masahiko Enari, Kanagawa (JP); Katsuya Hori, Kanagawa (JP)

(72) Inventors: Bunichiro Fujii, Chiba (JP); Hiroshi Okada, Kanagawa (JP); Masahiko Enari, Kanagawa (JP); Katsuya Hori, Kanagawa (JP)

(73) Assignee: SONY CORPORATION, Tokyo (JP)

(21) Appl. No.: 13/818,115

(22) PCT Filed: Aug. 11, 2011
(86) PCT No.: PCT/JP2011/004549

§ 371 Date: Feb. 21, 2013

(30) Foreign Application Priority Data
Sep. 6, 2010 (JP) 2010-198980

(51) Int. Cl. G06F 15/177

(52) U.S. Cl. CPC G06F 15/177
USPC 709/203

(57) ABSTRACT

A user device including a communication interface that communicates with a server, a sensor unit that detects at least one of a state of a user and a state of the user device, and a controller that controls an operating condition of the user device by receiving information from the server based on a comparison between an output of the sensor unit and stored setting description data associating the operating condition with a predetermined output of the sensor unit.

### TECHNICAL FIELD

The present disclosure relates to a user device, a server, and an operating conditions setting system.

### BACKGROUND ART

A user device has functions, such as an alarm, a scheduler, and the like, that perform certain operations in cases where specific operating conditions are satisfied. Setting of the operating conditions is ordinarily done by using an application that has been installed in the user device in advance to operate a setting screen (for example, PTL 1).

However, user devices, mainly portable types, have appeared on the market that are provided with detection functions that detect states of the user and/or of the environment surrounding the user. One example of such a detection function is a detection function that detects position information. Functions that detect position information are now provided in portable user devices such as mobile telephones and laptop personal computers (PCs). Furthermore, it is conceivable that various types of detection functions will be provided in the future, so that the user device can provide information that is suited to various types of user states.

### CITATION LIST

### Patent Literature

PTL 1: Japanese Patent Application Publication No. JP-A-2009-2767220

### SUMMARY

### Technical Problem

However, a problem exists in that the screen for setting the operating conditions as described above is established by the application that has been installed in advance, and flexible updating cannot be performed. For example, when new hardware is added, or when a new method is provided for utilizing detected information that has already been acquired, cases occur in which it is desirable to add new parameters to be used for the operating conditions and to modify combinations of operating conditions.

Accordingly, in order to address the problem described above, the present disclosure provides an operating conditions setting system, a user device, a setting server, and an operating conditions setting method that are novel and improved and that are capable of flexibly modifying setting items for the operating conditions by using the separate setting server to provide the screen for setting the operating conditions for the user device.

### Solution to Problem

According to one embodiment, the disclosure is directed to a user device, comprising: a communication interface configured to communicate with a server; a sensor unit configured to detect at least one of a state of a user and a state of the user device; and a controller configured to control an operating condition of the user device by receiving information from the server based on a comparison between an output of the sensor unit and stored setting description data associating the operating condition with a predetermined output of the sensor unit.

The user device may further include a display configured to display a setting screen received from the server, the setting screen configured to receive input setting information associating an operating condition of the user device with an output of the sensor unit. The interface may be configured to transmit the input setting information to the server. The interface may be configured to receive the setting description data from the server, the setting description data generated by the server based on the input setting information received from the user device. The setting description data may include at least one of setting identifiers identifying operating conditions set based on an output of the sensor unit, and operating conditions set by combining states of information detected by a plurality of sensor units of the user device. The controller may be configured to control an operating condition of the user device by comparing an output of the sensor unit to the setting description data.

The communication interface may be configured to transmit an output of the sensor unit to the server, and the controller may be configured to control an operating condition of the user device based on operating condition information received from the server.

The sensor unit may include at least one of a vibration sensor, acceleration sensor, velocity sensor, position sensor, direction sensor, environmental sound sensor, temperature sensor, humidity sensor, barometric pressure sensor, image sensor, time sensor, electrical potential sensor, electric current sensor, photoelectricity sensor, an infrared light sensor.

According to another embodiment, the disclosure is directed to a server comprising: a processor configured to generate a setting screen configured to receive an input associating an operating condition of a user device with a predetermined output of a sensor unit of the user device; an interface configured to receive input setting information associating the operating condition of the user device with the predetermined output of the sensor unit of the user device, wherein the processor is configured to generate setting description data associating the operating condition with the predetermined output of the sensor unit based on the input setting information.

The server may include a communication interface configured to transmit the setting screen to the user device.

The communication interface may be configured to receive the input setting information from the user device.

The server may further include a communication interface configured to transmit the setting description data to the user device.

The server may further include a communication interface configured to receive an output of the sensor unit at the user device, the sensor unit configured to detect at least one of a state of a user and a state of the user device.

The processor may be configured to determine an operating condition of the user device by comparing the received output of the sensor unit to the setting description data.

The communication interface may be configured to transmit information to the user device indicating the operating condition of the user device based on the comparing.

The communication interface may be configured to communicate with at least one of a plurality of linked server configured to process the output of the sensor unit received from the user device.

The processor may be configured to determine an operating condition of the user device based on data received from the at least one of the plurality of linked servers.

The communication interface may be configured to transmit a command to a distribution server based on the determined operating condition, the command causing the distribution server to distribute content to the user device.

According to another embodiment, the disclosure is directed to an operating conditions setting system comprising: a processor, at a server, configured to generate a setting screen configured to receive input associating an operating condition of a user device with a predetermined output of a sensor unit of the user device; a first communication interface, at the user device, configured to receive the setting screen from the server; a user interface, at the user device, configured to display the setting screen and receive input setting information associating an operating condition of the user device with an output of the sensor unit as input setting information; a second communication interface, at the server, configured to receive the input setting information from the user device; and a processor, at the server, configured to generate setting description data associating the operating condition with the predetermined output of the sensor unit based on the received input setting information.

### Advantageous Effects of Invention

According to the present disclosure that has been described above, the setting items for the operating conditions can be modified flexibly by using the setting server to provide the screen for setting the operating conditions for the user device.

### BRIEF DESCRIPTION OF DRAWINGS

FIG. 1 is a structural diagram that shows an example of a setting system according to an embodiment of the present disclosure.

FIG. 2 is an explanatory figure that shows examples of linked servers according to the present embodiment.

FIG. 3 is a block diagram that shows a configuration of a user device according to the present embodiment.

FIG. 4 is a block diagram that shows an example of a detailed configuration of a control portion of the user device according to the present embodiment.

FIG. 5 is a block diagram that shows another example of a detailed configuration of the control portion of the user device according to the present embodiment.

FIG. 6 is a table that shows examples of sensors that are installed in the user device according to the present embodiment and information that is acquired from the sensors.

FIG. 7 is a block diagram that shows a configuration of a setting server according to the present embodiment.

FIG. 8 is a flowchart that shows an example of a setting operation in the setting server according to the present embodiment.

FIG. 9 is a table that shows examples of items of setting description data that are created by the setting server according to the present embodiment.

FIG. 10 is a table that shows examples of information that is learned by one of the linked servers according to the present embodiment.

FIG. 11 is a table that shows types of content that are played back by the user device according to the present embodiment and equipment for using the content.

FIG. 12 is an explanatory figure that shows an overview of a network-distributed public broadcasting system that is a first example.

FIG. 13 is an explanatory figure that shows an effect of an on-site broadcast distribution system in the first example.

FIG. 14 is an explanatory figure that shows an example of the setting description data in the first example.

FIG. 15 is a flowchart that shows the operation of the user device in the first example.

FIG. 16 is a sequence diagram that shows the operation of the setting system in a modified example of the first example.

FIG. 17 is an explanatory figure that shows an overview of an intelligent alarm system that is a second example.

FIG. 18 is an explanatory figure that shows an overview of the intelligent alarm system in the second example.

FIG. 19 is an explanatory figure that shows an example of the setting description data in the second example.

FIG. 20 is an explanatory figure that shows an example of the operation of the user device in the second example.

FIG. 21 is a table that shows detected values that the user device acquires in the first and the second examples and methods for using the detected values.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the explanation will be in the order shown below.

1. System overview

2. Configuration of user device

3. Configuration of setting server

4. First example

5. Second example

6. Conclusion

### 1. SYSTEM OVERVIEW

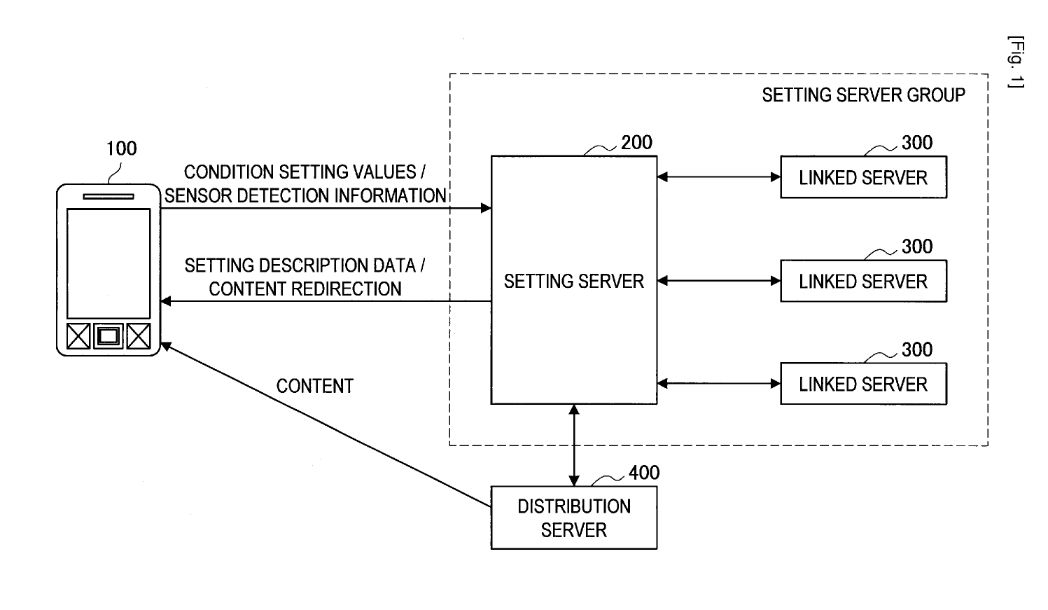

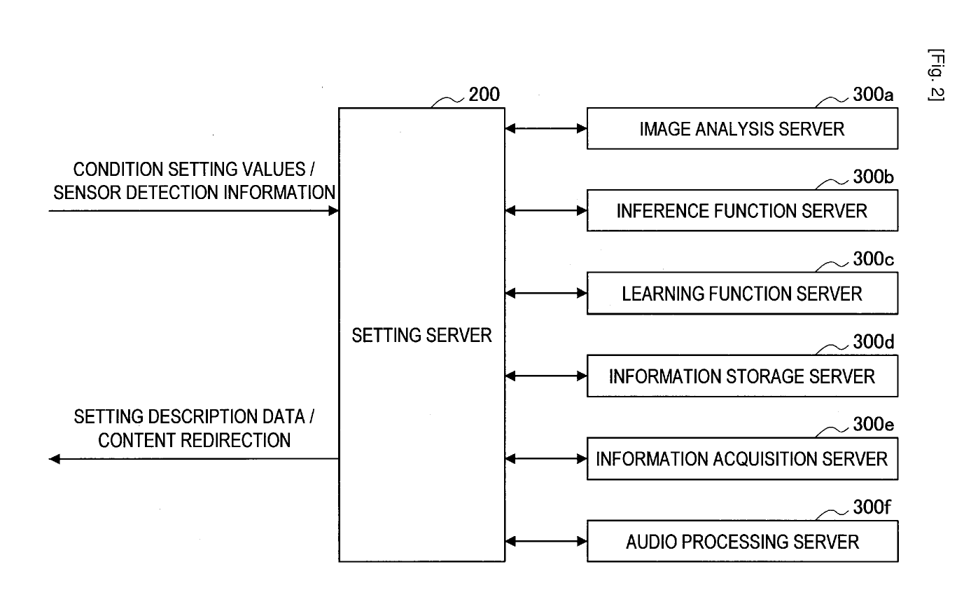

First, an overview of a setting system 1 according to an embodiment of the present disclosure will be explained with reference to FIGS. 1 and 2. FIG. 1 is a structural diagram that shows an example of the setting system 1 according to the present embodiment of the present disclosure. FIG. 2 is an explanatory figure that shows examples of linked servers according to the present embodiment.

Referring to FIG. 1, the setting system 1 includes a user device 100, a group of setting sites that includes a setting server 200 and linked servers 300, and a distribution server 400.

The user device 100 is an information processing device that has a communication function and a content playback function, and it is also a device that has a detection function that detects a state of a user who is using the user device 100 and/or a state of the environment surrounding the user. The user device 100 is able to launch the content playback function in accordance with operating conditions that are based on information that is detected by the detection function. The content playback function may be provided as an alarm function in which content is played back when a time condition is satisfied, but the content playback function that is provided in the present embodiment utilizes various types of detection functions to detect more combinations of user states under more complex operating conditions. The configuration of the user device 100 will be described in detail later.

Note that the user device 100 may be an information processing apparatus such as a mobile telephone, a portable music playback device, a portable video processing device, a portable game device, a PC, a home game device, a household electrical appliance, a home video processing device (a DVD recorder, a video deck, or the like), a personal digital assistant (PDA), or the like, for example.

The setting server 200 provides a setting site for selecting and inputting setting items for the operating conditions for the user device 100. The setting server 200 sets the operating conditions for the user device 100 based on information inputting by using a setting screen on the setting site. The setting server 200 is able to transmit to the user device 100 setting description data that describe the operating conditions. In this case, the user device 100 has a function that determines whether the operating conditions have been satisfied according to the setting description data. The setting server 200 may also have a function that stores the setting description data in one of the setting server 200 and an external storage portion and a function that determines whether the operating conditions have been satisfied.

The setting server 200 is also connected through communication lines to the linked servers 300, which provide various types of functions, and the setting server 200 is able to utilize the functions that the linked servers 300 provide. The setting server 200 is also connected through a communication line to the distribution server 400 and is able to perform control such that the distribution server 400 distributes content to the user device 100. Through its links to the external servers, the setting server 200 can take detection information that has been acquired from the user device 100 and transmit it to the linked servers 300, for example, and can also acquire results of analyses of the detection information from the linked servers 300.

The linked servers 300 provide linked sites that provide various types of functions that can be utilized from the setting site. The linked servers 300 are connected to the setting server 200 through a communication network. Note that in FIG. 1 the setting server 200 is connected to three of the linked servers 300, but the setting server 200 can be connected to as many of the linked servers 300 as necessary. The linked servers 300 may also perform any necessary processing by being linked to one another. Specific examples of the linked servers 300 will be explained with reference to FIG. 2.

In FIG. 2, an image analysis server 300a, an inference function server 300b, a learning function server 300c, an information storage server 300d, an information acquisition server 300e, and an audio processing server 300f are shown as examples of the linked servers 300. The setting server 200 transmits to the linked servers 300 the detection information that has been acquired from the user device 100, information that pertains to the user of the user device 100, and the like. The linked servers 300 transmit to the setting server 200 information that the linked servers 300 have one of acquired and created based on the information received from the setting server 200.

The image analysis server 300a has a function that performs image processing on image data that are received. For example, the image analysis server 300a may analyze the image data and output results of analysis. An example of the image analysis that is performed might be the identifying of a subject and a scene, using face recognition or mechanical learning, for example. In that case, the image analysis server 300a could output an analysis result for the image data that says, for example, “This is an image that includes a user A as the subject and that was taken at the seashore.”

The inference function server 300b has a function that outputs inference information that is inferred from the received information. For example, the inference function server 300b might infer and output a degree of discomfort for the user based on received information such as the air temperature, the humidity, the barometric pressure, sounds, and the like.

The learning function server 300c has a function that performs learning based on the received information and outputs learned information. For example, the learning function server 300c might have a function that learns the user's daily life patterns based on the received information. From a history of position information for the user, for example, the learning function server 300c could learn the position of the user's company or school, the position of the user's home, and the like. The learning function server 300c could also learn the user's wake-up time and bedtime, based on physiological inform such as the user's body temperature, pulse, brain waves, and the like.

The information storage server 300d is a server that functions as an external storage portion. For example, the information storage server 300d may be a server that stores movement tracking information that serves as the history of position information for the user. The information storage server 300d may store received data as is and may also have a function that processes information into an easily used state before storing it.

The information acquisition server 300e is a server that acquires necessary information based on information that is input. The audio processing server 300f has a function that performs processing on received audio data. The linked servers 300 may also provide various sorts of functions other than those described here. The setting system 1 is able to flexibly utilize the processing it requires by utilizing the functions of the linked servers 300.

### 2. CONFIGURATION OF USER DEVICE

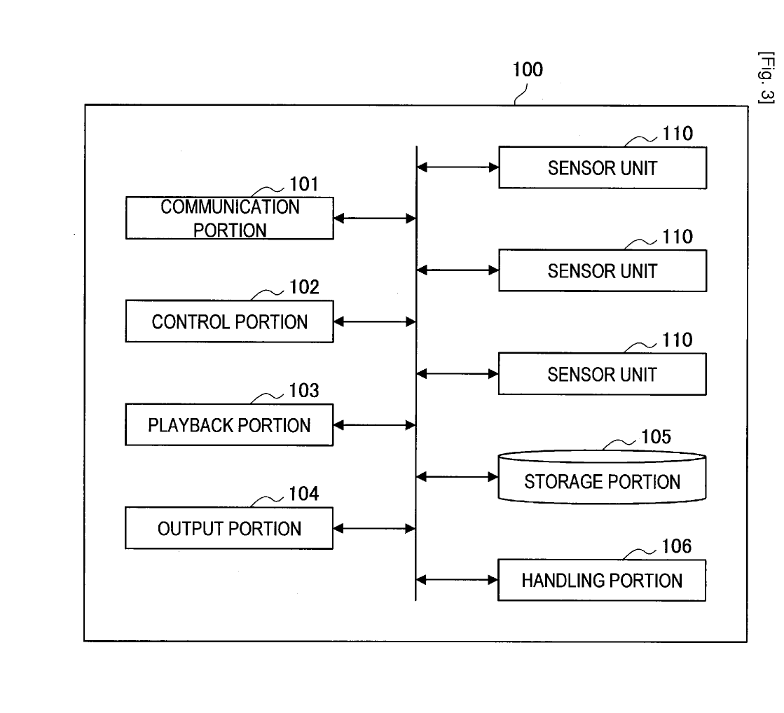

Next, a functional configuration of the user device 100 according to the present embodiment will be explained with reference to FIG. 3. FIG. 3 is a block diagram that shows the functional configuration of the user device 100 according to the present embodiment.

The user device 100 is an information processing device that has the communication function, the content playback function, and the detection function that detects information that indicates a state that pertains to the user of the user device 100. The user device 100 mainly includes a communication portion 101, a control portion 102, a playback portion 103, an output portion 104, a storage portion 105, an HANDLING PORTION 106, and at least one sensor unit 110.

The communication portion 101 is a communication interface that is configured from a communication device or the like for connecting to a communication network such as the Internet or the like, for example. For example, in a case where the communication portion 101 performs wireless communication, the communication portion 101 may include a communication antenna for transmitting and receiving signals that are involved in communication, as well as processing circuits and the like for performing various types of signal processing that are involved in communication. The communication portion 101 may also be a communication interface that performs wired communication. Through the communication network, the communication portion 101 transmits to and receives from the setting server 200 various types of data such as information on an operation on the setting screen and detection information from a sensor, as well as setting description data and the like that are created based on the handling information and the detection information.

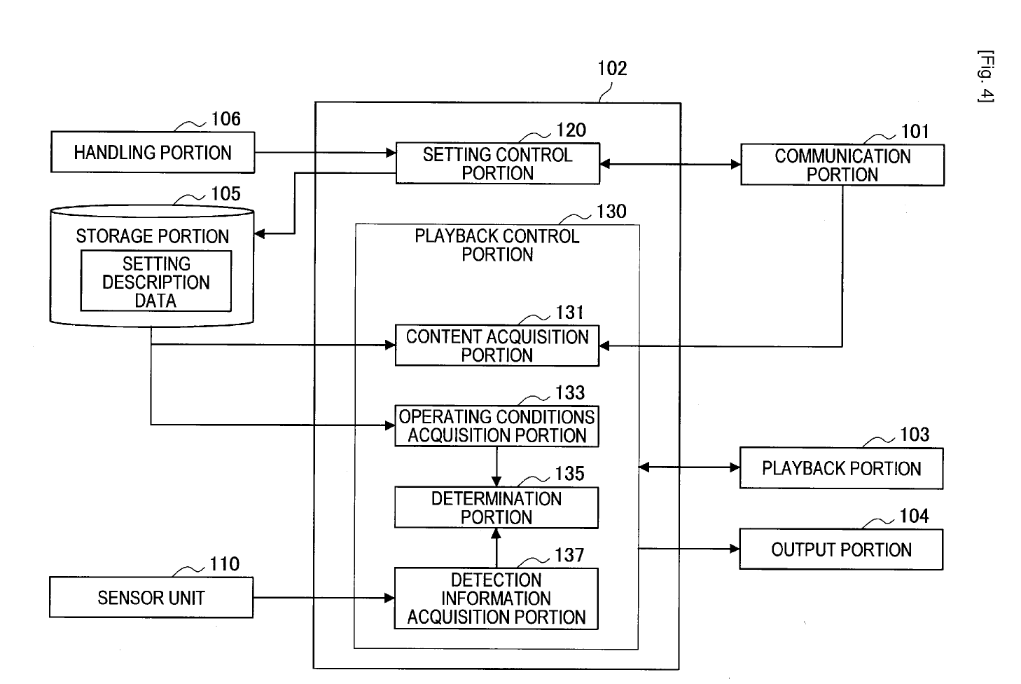

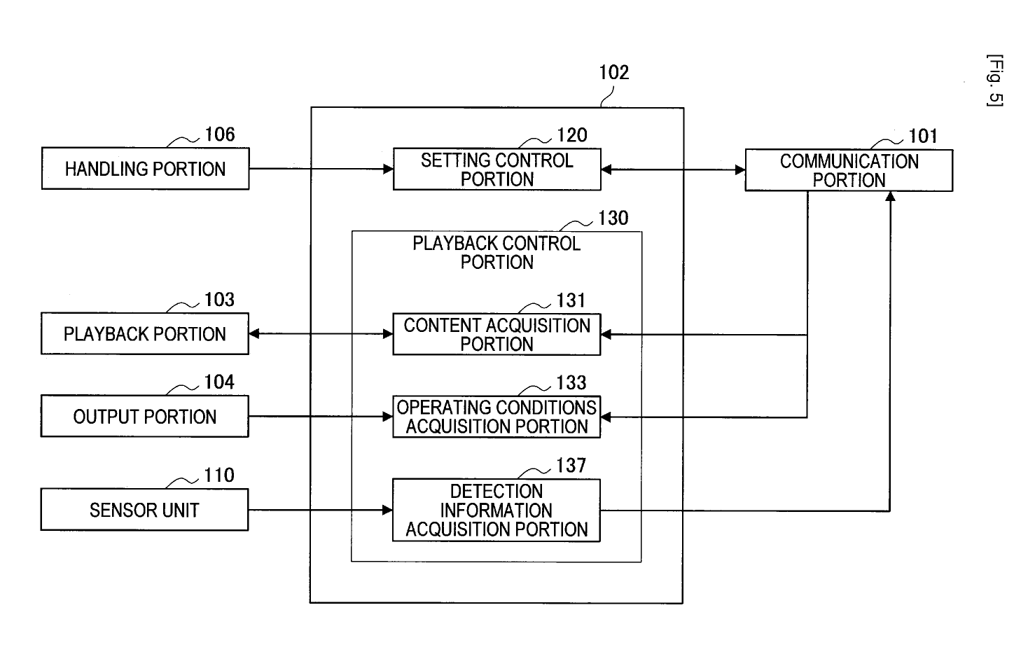

The control portion 102 controls the overall operation of the user device 100. The control portion 102 mainly functions as a setting control portion 120 and a playback control portion 130 (refer to FIGS. 4 and 5). The setting control portion 120 has a function that controls the setting of the operating conditions for the playback function of the user device 100. In the present embodiment, the operating conditions may include, for example, a starting up condition for the playback function and various types of set values that are involved in playback. The playback control portion 130 controls the operation of the playback function of the user device 100. The functions of the control portion 102 will be described in detail later using FIGS. 4 and 5.

The playback portion 103 performs the playback of content in accordance with the control of the playback control portion 130. The content that is played back is output from the output portion 104.

The output portion 104 has a function that outputs information to the user. The information that is output may be provided to the user in the form of a display screen, a voice, or the like, for example. The output portion 104 may be configured from a display unit such as a liquid crystal display (LCD) unit, an organic light-emitting diode (OLED) unit, a cathode ray tube (CRT) display unit, a lamp, or the like, and from an audio output unit such as a speaker or the like, for example. The output portion 104 output the content that is played back. Specifically, a display unit displays various types of information, such as image data and the like that are played back, as one of text and images. On the other hand, an audio output unit converts audio data that are played back into sound and outputs the sound. The output portion 104 may also be an interface that is connected to one of an external display unit and an external audio output unit.

The storage portion 105 has a function that stores various types of data that are used in the user device 100. The storage portion 105 can include a storage medium, a storage device that stores data in a storage medium, a reading device that reads data from a storage medium, a deletion device that deletes data that are stored in a storage medium, and the like. The storage medium that is used may be one of a non-volatile memory, such as a flash memory, an electronically erasable and programmable read-only memory (EEPROM), a magnetoresistive random access memory (MRAM), a ferroelectric random access memory (FeRAM), a phase change random access memory (PRAM), or the like, and may also be a magnetic storage medium such as a hard disk drive (HDD) or the like. In the present embodiment, the storage portion 105 stores a program that the control portion 102 executes, content that the playback portion 103 plays back, setting description data that have been received from the setting server 200 and that include the operating conditions, and the like.

The HANDLING PORTION 106 has a function for inputting various types of information to the user device 100 in accordance with a user operation. For example, the HANDLING PORTION 106 may be configured from an input portion, such as a touch panel, a mouse, a keyboard, a button, a microphone, a switch, a lever, or the like, for allowing the user to input information, as well as an input control circuit or the like that creates an input signal based on the input by the user and outputs the input signal to the control portion 102.

The sensor unit 110 has the detection function that detects one of a state of the user of the user device 100 and/or a state of the environment surrounding the user. The sensor unit 110 can include a sensor that has the detection function and a processing portion that performs various types of processing on a detected value. The sensor unit 110 outputs one of a value that is detected by the sensor and detection information that is information that has resulted from the processing of the detected value.

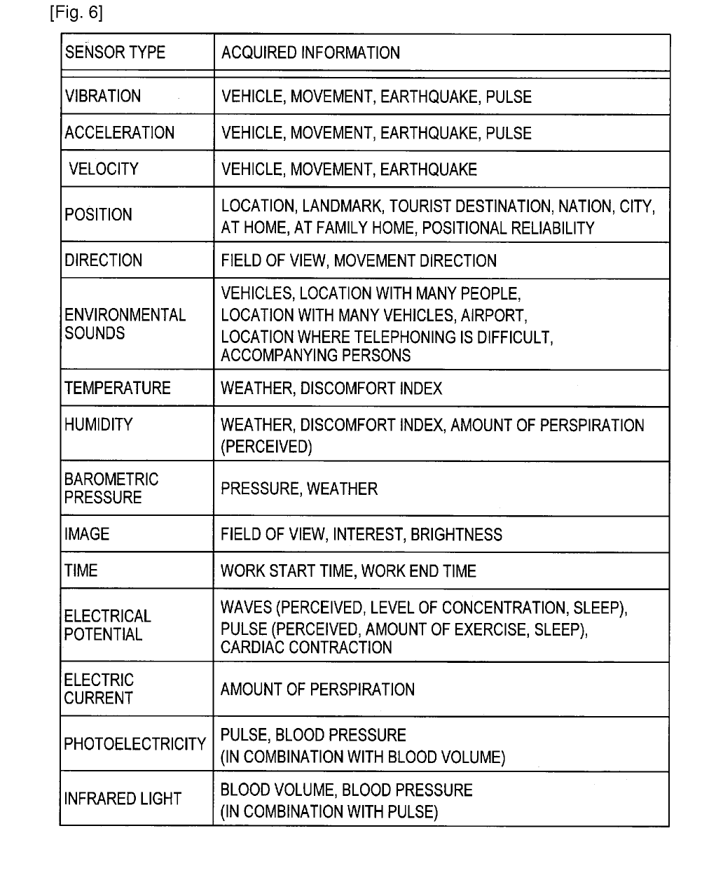

The sensor unit 110 may be any unit that has the detection function that detects one of a state of the user and/or a state of the environment surrounding the user. For example, relationships between detected values that are acquired by sensors and detection information that can be obtained by applying processing to the detected values are shown in FIG. 6. The sensor unit 110 may also be a unit that includes sensors that acquire the various types of detected values that are shown in FIG. 6. The processing for obtaining the detection information from the detected values can be performed in at least one of the user device 100 itself, the setting server 200, and the linked servers 300.

Note that among the detection information that is shown in FIG. 6, the positional reliability that is obtained from the position information is information that indicates the reliability of the position information. For example, the positional reliability can be determined based on a history of the position information, the position of the user's home, and the position of the user's workplace, as well as by learning mean values for the time that the user leaves home, the time that the user returns home, and the like. It is therefore possible to detect whether the user is acting according to the usual pattern or is acting differently from the usual pattern.

Furthermore, depending on the type of the sensor that is used, cases will occur in which it is necessary to establish a specific positional relationship with respect to the user in order to obtain the detected value. For example, in a case where brain waves are obtained, it might be necessary to attach a sensor to the user's head. In a case such as this, where the sensor must be attached in a specific position, the sensor must be able to be attached to the user's body, either by providing the user device 100 in a wearable form or by using a separate accessory.

The configuration of the control portion 102 will be explained in detail with reference to FIGS. 4 and 5. Two cases will be considered, one in which the operating conditions for the user device 100 that have been set on the setting screen that is provided by the setting server 200 are transmitted to the user device 100 as the setting description data, and one in which the operating conditions are stored in the setting server 200 and a determination is made by the setting server 200 as to whether the playback function of the user device 100 will be started. The configuration for the first of these cases is shown in FIG. 4, and the configuration for the latter case is shown in FIG. 5.

First, referring to FIG. 4, the control portion 102 of the user device 100 mainly has the function of the setting control portion 120 and the function of the playback control portion 130. The setting control portion 120 controls the setting of the operating conditions, which can include the starting up condition for the playback function of the user device 100, the content to be played back, the playback volume, and the like. The setting control portion 120 displays on the output portion 104 the setting screen that the setting server 200 provides, acquires the information on the user's operation of the setting screen, and transmits the acquired handling information to the setting server 200 through the communication portion 101. The setting control portion 120 acquires the setting description data that have been received from the setting server 200 through the communication portion 101 and stores the acquired setting description data in the storage portion 105.

The playback control portion 130 controls the operation of the content playback by the playback portion 103. The playback control portion 130 also has functions of a content acquisition portion 131, an operating conditions acquisition portion 133, a determination portion 135, and a detection information acquisition portion 137. The playback control portion 130 controls the playback operation by the playback portion 103 based on the operating conditions that are described in the setting description data, which are acquired from the storage portion 105 by the operating conditions acquisition portion 133, and based on the detection information that is acquired from the sensor unit 110 by the detection information acquisition portion 137. Note that the determination portion 135 determines whether the starting up condition for the playback function, which is included among the operating conditions, has been satisfied, based on the operating conditions and the detection information. When the determination portion 135 has determined that the starting up condition has been satisfied, the playback control portion 130 uses the content acquisition portion 131 to acquires the content in accordance with information on the content that is to be played back, that information being included in the operating conditions. The content acquisition portion 131 may acquire the content that is stored in the storage portion 105 and may also acquire the content from the external distribution server 400 through the communication portion 101. The playback control portion 130 then plays back, in accordance with the operating conditions, the content that has been acquired by the content acquisition portion 131. The playback control portion 130 may also use the determination portion 135 to determine at regular intervals whether the starting up condition has been satisfied.

The configuration of the user device 100 in the case where the user device 100 determines whether the starting up condition in the operating conditions has been satisfied, in accordance with the setting description data that have been received in advance from the setting server 200 (hereinafter called the independent type, in the sense that the user device 100 operates independently), has been explained with reference to FIG. 4. Next, the configuration of the user device 100 in the case where the setting server 200 determines whether the starting up condition has been satisfied (hereinafter called the push type) will be explained with reference to FIG. 5. The flow of the data in the push type is different from the flow in the independent type, because the unit that performs the determination of the starting up condition is different.

The configuration of the control portion 102 in the push type user device 100 is shown in FIG. 5. The control portion 102 mainly has the function of the setting control portion 120 and the function of the playback control portion 130. The setting control portion 120 displays on the output portion 104 the setting screen that the setting server 200 provides, acquires the information on the user's operation of the setting screen, and transmits the acquired handling information to the setting server 200 through the communication portion 101.

In the push type user device 100, the operating conditions are stored in the setting server 200, and the determination of whether the starting up condition has been satisfied is made by the setting server 200. Therefore, in the playback control portion 130, the operating conditions acquisition portion 133 acquires a pushed start command and the operating conditions from the setting server 200 through the communication portion 101. Note that in a case where the detection information is required for the determination of the operating conditions in the setting server 200, the detection information is acquired from the sensor unit 110 by the detection information acquisition portion 137 in response to a request from the setting server 200. The detection information acquisition portion 137 transmits the acquired detection information to the setting server 200 through the communication portion 101. Further, the content acquisition portion 131 acquires, through the communication portion 101, content that has been transmitted in accordance with a request for content distribution from the setting server 200 to the distribution server 400.

Examples of the functions of the user device 100 according to the present embodiment have been described above. The various structural elements that have been described above may be configured from general-purpose components and circuits, and they may also be configured from hardware that is specialized for the functions of the various structural elements. The functions of the various structural elements may also be performed by reading, from one of a read-only memory (ROM) and a random access memory (RAM), a control program that describes a processing procedure by which a computational device such as a central processing unit (CPU) or the like implements the functions of the structural elements, then interpreting and executing the control program. It is therefore possible to modify the configuration that is used in a manner that is appropriate to the level of the technology at the time that the present embodiment is implemented.

Note that it is possible to create a computer program for implementing the various functions of the user device 100 according to the present embodiment as described above, and to install that program in a personal computer or the like. It is also possible to provide a computer-readable storage medium in which a computer program of this sort is stored. The storage medium may be a magnetic disk, an optical disk, a magnet-optical disk, a flash memory, or the like, for example. The computer program described above may also be distributed through a network, for example, instead of using a storage medium.

### 3. CONFIGURATION OF SETTING SERVER

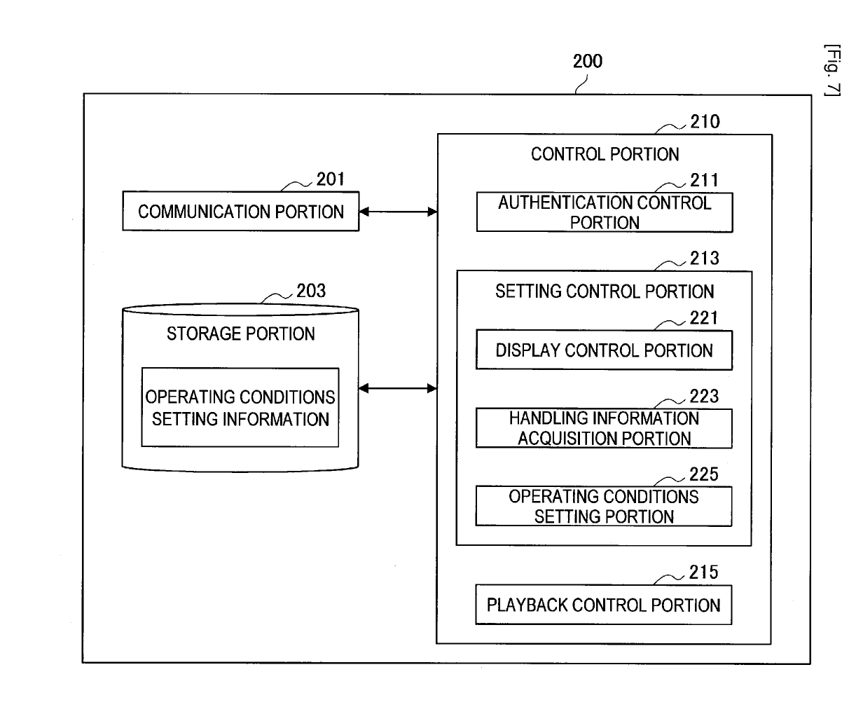

Next, the configuration of the setting server 200 will be explained with reference to FIG. 7. FIG. 7 is a block diagram that shows the configuration of the setting server 200 according to the present embodiment.

The setting server 200 accepts access from the user device 100 and provides the setting screen for setting the operating conditions for the user device 100. Note that at this time, the user device 100 that performs the setting of the operating conditions is not necessarily the user device 100 for which the operating conditions are set. The user device 100 that performs the setting of the operating conditions may be a separate device that is held by the user of the user device 100 for which the operating conditions are set. The user device 100 that performs the setting of the operating conditions may also be a user device 100 that is held by a different user. Note that in a case where the operating conditions are set for a user device 100 that is held by a different user, it is desirable to use a user ID, an ID that identifies the user device 100, or the like to restrict the user device 100 that is allowed to perform the setting operation.

The setting server 200 mainly has a communication portion 201, a storage portion 203, and a control portion 210. The control portion 210 mainly functions as an authentication control portion 211, a setting control portion 213, and a playback control portion 215.

The communication portion 201 is a communication interface that is configured from a communication device or the like for connecting to a communication network such as the Internet or the like, for example. For example, in a case where the communication portion 201 performs wireless communication, the communication portion 201 may include a communication antenna for transmitting and receiving signals that are involved in communication, as well as processing circuits and the like for performing various types of signal processing that are involved in communication. The communication portion 201 may also be a communication interface that performs wired communication. Through the communication network, the communication portion 201 transmits to and receives from the user device 100 various types of data such as information on an operation on the setting screen and detection information from a sensor, as well as setting description data and the like that are created based on the handling information and the detection information.

The storage portion 203 has a function that stores various types of data that are used in the setting server 200. The storage portion 203 can include a storage medium, a storage device that stores data in a storage medium, a reading device that reads data from a storage medium, a deletion device that deletes data that are stored in a storage medium, and the like. The storage medium that is used may be one of a non-volatile memory, such as a flash memory, an electronically erasable and programmable read-only memory (EEPROM), a magnetoresistive random access memory (MRAM), a ferroelectric random access memory (FeRAM), a phase change random access memory (PRAM), or the like, and may also be a magnetic storage medium such as a hard disk drive (HDD) or the like. In the present embodiment, the storage portion 203 can store a program that the control portion 210 executes, authentication information that the authentication control portion 211 uses for authentication, the operating conditions that have been set based on information on the operation of the setting screen, and the like.

The control portion 210 controls the overall operation of the setting server 200. The control portion 210 uses the authentication control portion 211 to perform authentication of a user who accesses the setting server 200. In a case where the user is a registered user, the setting control portion 213 creates and provides the setting screen based on user information. The user information may be information that is registered in advance in association with a user ID, and it may also be acquired from the accessing user device 100 at the same time that the authentication is performed. For example, the setting control portion 213 can acquire information on the type of the sensor unit 110 that the user device 100 has and can create the operating conditions setting screen based on setting conditions that can be set in the user device 100.

The setting control portion 213 receives information on operations that are performed in the user device 100 with respect to the setting screen and sets the operating conditions based on that handling information. In a case where the user device 100 configuration is the independent type, the setting control portion 213 creates the setting description data based on the operating conditions and transmits the setting description data to the user device 100 through the communication portion 201. In contrast, in a case where the user device 100 configuration is the push type, the setting control portion 213 stores the set operating conditions in the storage portion 203. In a case where the user device 100 configuration is the push type, the playback control portion 215 determines, at regular intervals, whether the starting up condition in the stored operating conditions has been satisfied. In a case where the starting up condition has been satisfied, the playback control portion 215 transmits the start command and the operating conditions to the user device 100. The playback control portion 215 can also issue a command to the distribution server 400 to distribute content to the user device 100. Note that among the functions of the setting control portion 213, the function that controls the display of the setting search condition is called a display control portion 221, the function that acquires the handling information for setting screen from the user device 100 or the like is called an handling information acquisition portion 223, and the function that determines the operating conditions based on the acquired handling information and creates the setting description data is called an operating conditions setting portion 225.

Examples of the functions of the setting server 200 according to the present embodiment have been described above. The various structural elements that have been described above may be configured using general-purpose components and circuits, and they may also be configured from hardware that is specialized for the functions of the various structural elements. The functions of the various structural elements may also be performed by reading, from one of a read-only memory (ROM) and a random access memory (RAM), a control program that describes a processing procedure by which a computational device such as a central processing unit (CPU) or the like implements the functions of the structural elements, then interpreting and executing the control program. It is therefore possible to modify the configuration that is used in a manner that is appropriate to the level of the technology at the time that the present embodiment is implemented.

Note that it is possible to create a computer program for implementing the various functions of the setting server 200 according to the present embodiment as described above, and to install that program in a personal computer or the like. It is also possible to provide a computer-readable storage medium in which a computer program of this sort is stored. The storage medium may be a magnetic disk, an optical disk, a magnet-optical disk, a flash memory, or the like, for example. The computer program described above may also be distributed through a network, for example, instead of using a storage medium.

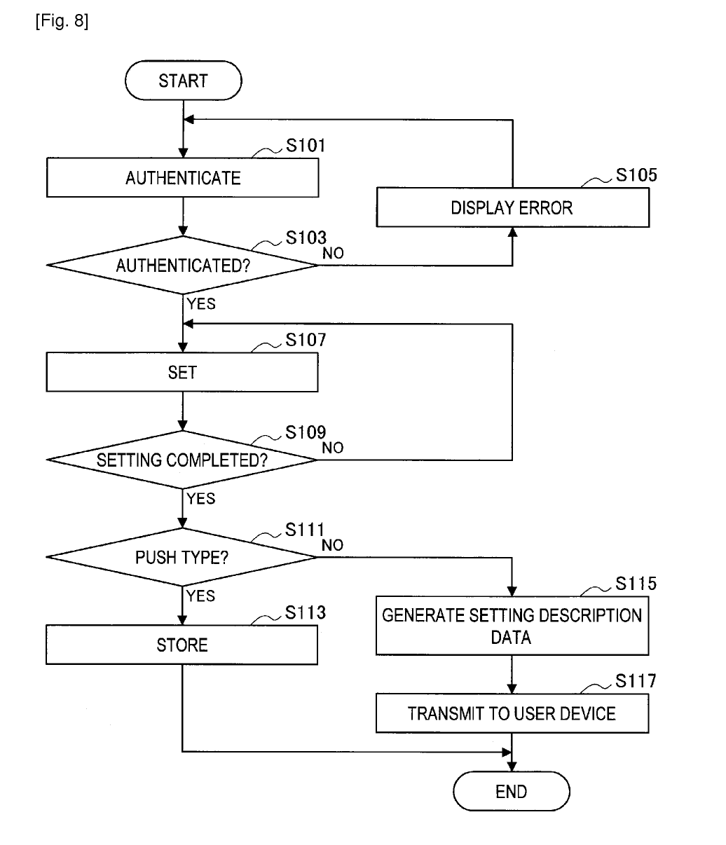

Next, the flow of the setting processing for the operating conditions will be explained with reference to FIG. 8. FIG. 8 is a flowchart that shows an example of a setting operation in the setting server according to the present embodiment.

First, the authentication control portion 211 of the setting server 200 performs authentication processing for the user who is accessing the setting server 200 (Step S101). For example, the authentication processing may be performed by acquiring the user ID for the user who is accessing the setting server 200, then checking the user ID against user information that has been registered in advance. The checking processing may be performed within the setting server 200 and may also be performed by a separate authentication server. The authentication control portion 211 whether the user who is accessing the setting server 200 is a registered user (Step S103). In a case where the user is not authenticated, the authentication control portion 211 displays an error display screen (Step S105).

On the other hand, in a case where the user is authenticated, next, the setting control portion 213 creates and provides the setting screen for the user and performs the setting processing for the operating conditions by receiving the handling information for the setting screen (Step S107). The setting control portion 213 determines whether the setting processing has been completed (Step S109). In a case where it is determined at Step S109 that the setting processing has been completed, next, the setting control portion 213 determines whether the operating conditions that have been set are for the push type configuration (Step S111). For example, a choice between the push type and the independent type may be provided as a setting item on the setting screen, and the determination may be made based on the handling information for the setting screen. In a case where the push type is selected, the setting control portion 213 stores the set operating conditions so that the starting up condition can be determined by the setting server 200 (Step S113). On the other hand, in a case where it is determined at Step S111 that the configuration is the independent type, the setting control portion 213 creates the setting description data based on the set operating conditions (Step S115) and transmits the setting description data to the user device 100 (Step S117).

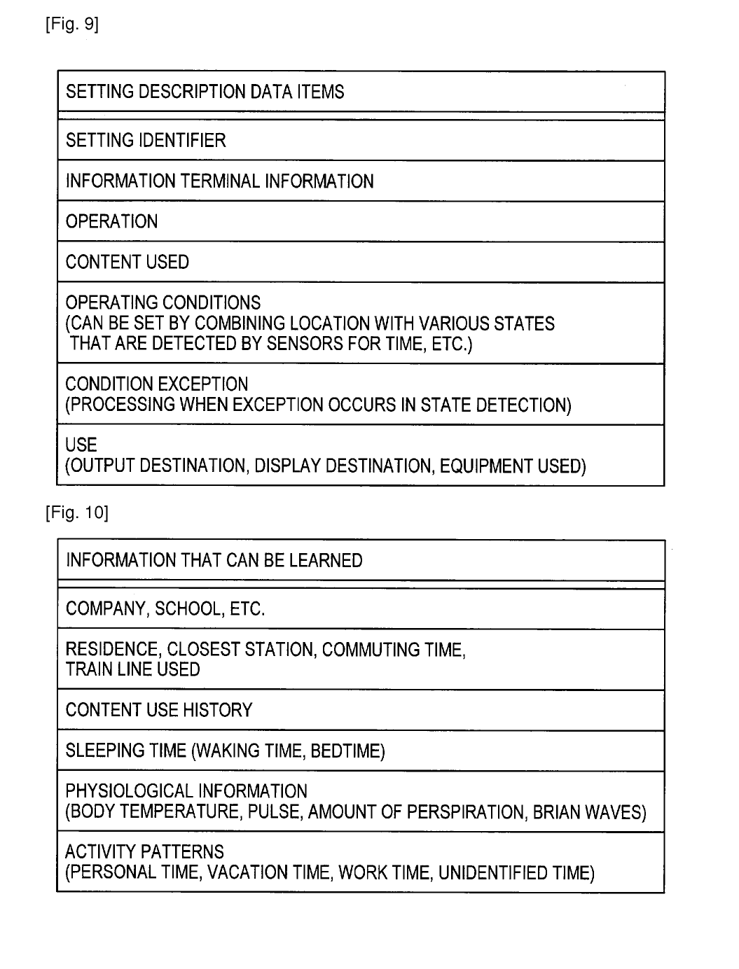

Examples of description items in the created setting description data are shown in FIG. 9. The setting description data may include, for example, setting identifiers for identifying the operating conditions that are set, information terminal information, which is information that pertains to the user device 100, information that pertains to an handling information on the content that will be used by an operation, the operating conditions that have been set by combining states of the information that has been detected by the sensors, information about processing in a case where an exception occurs, and information about uses, including an output destination, a display destination, equipment for using the content, and the like.

Note that learned information that has been learned based on the detected values from the sensors can be used as the operating conditions in the setting description data. For example, results of complex analyses can be used more easily by utilizing the functions of the learning function server 300c that is provided as one of the linked servers 300. Moreover, a case where a history of the values that have been detected by the sensors is necessary for the learning can be handled by utilizing a storage portion of the learning function server 300c, even in a case where the storage capacity of the user device 100 itself is insufficient.

Examples of information that can be learned are shown in FIG. 10. For example, the positions of a company and a school can be learned by the learning function server 300c based on a history of the position information for the user device 100. It is also possible to learn the positions of the user's residence and the closest station, as well as the user's commuting time and the train line used for the commute. Alternatively, learning a history of content use would make it possible to learn the user's patterns of using the user device 100, such as information on preferred content, the times that the content is used, and the like. Learning a history of physiological information would make it possible to learn the amount of time that the user sleeps, specifically the user's wake-up time and bedtime. Furthermore, combining various types of the detection information would make it possible to learn the user's activity patterns. For example, it would be possible to know how the user ordinarily spends his working time and leisure time, the places he goes, and the like. These kinds of learned information can be used as the operating conditions, as described above.

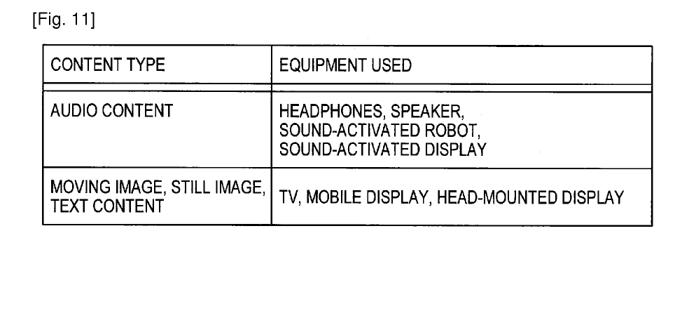

Examples of equipment for using the content, as described in the setting description data, are shown in FIG. 11. FIG. 11 is a table that shows types of content that are played back by the user device 100 according to the present embodiment and the equipment for using the content. In a case where the content that will be played back by the user device 100 is audio content, the equipment for using the content, as described in the setting description data, can include, for example, headphones, a speaker, a sound-activated robot, a sound-activated display, and the like, as the output destination. In a case where the content that will be played back by the user device 100 is one of moving image content, still image content, text content, and the like, the equipment described in the setting description data can include a television set, a built-in display, a head-mounted display, and the like as the output destination.

The setting system 1 according to the present embodiment has been explained above. Up to this point, a general configuration has been explained, but next, two examples of specific forms of the setting system 1 will be explained. First, a first example of a network-distributed public broadcasting system that distributes audio data for public broadcasting through a network will be explained. A second example of an intelligent alarm system that, based on detected values from sensors, is able to provide information that is better suited to the user's state in accordance with more complex operating conditions will also be explained.

### 4. FIRST EXAMPLE

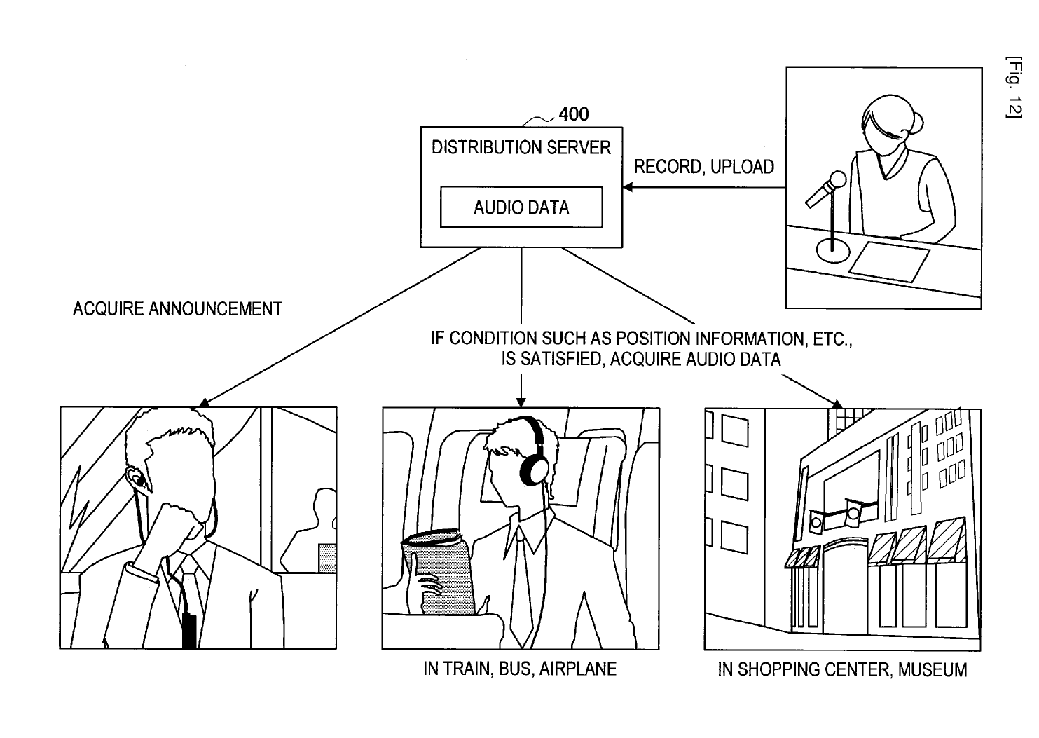

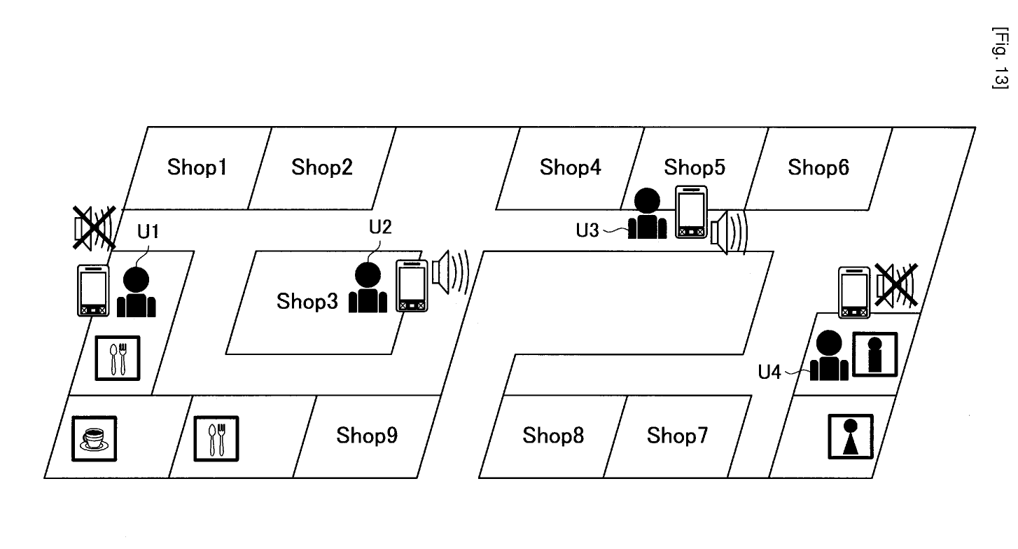

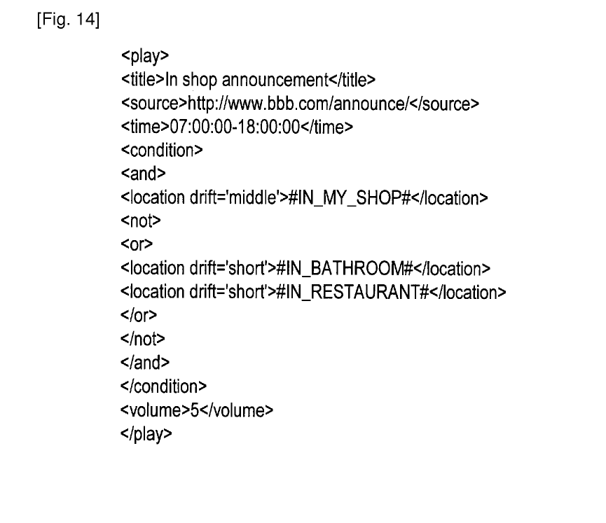

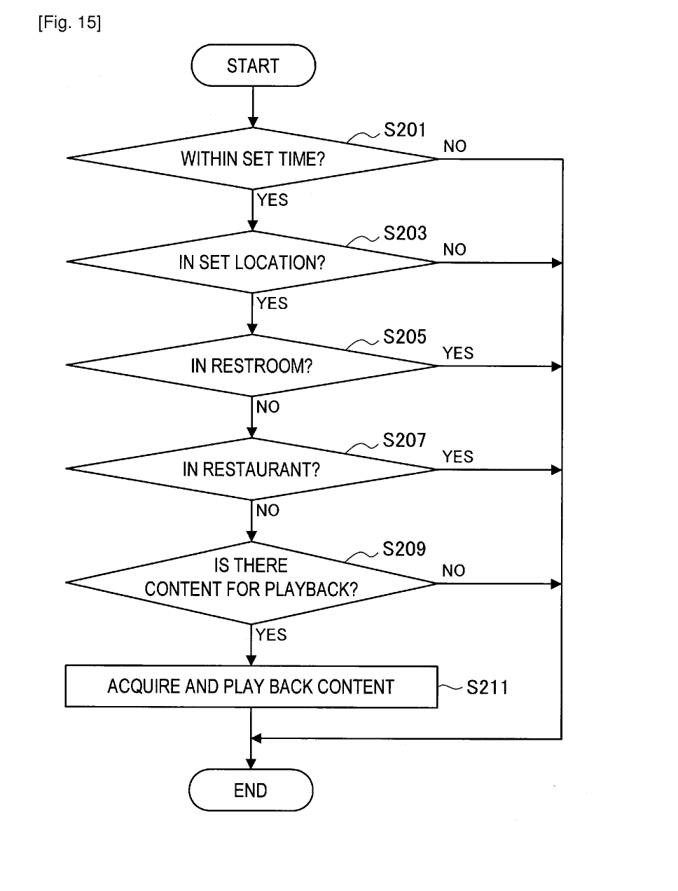

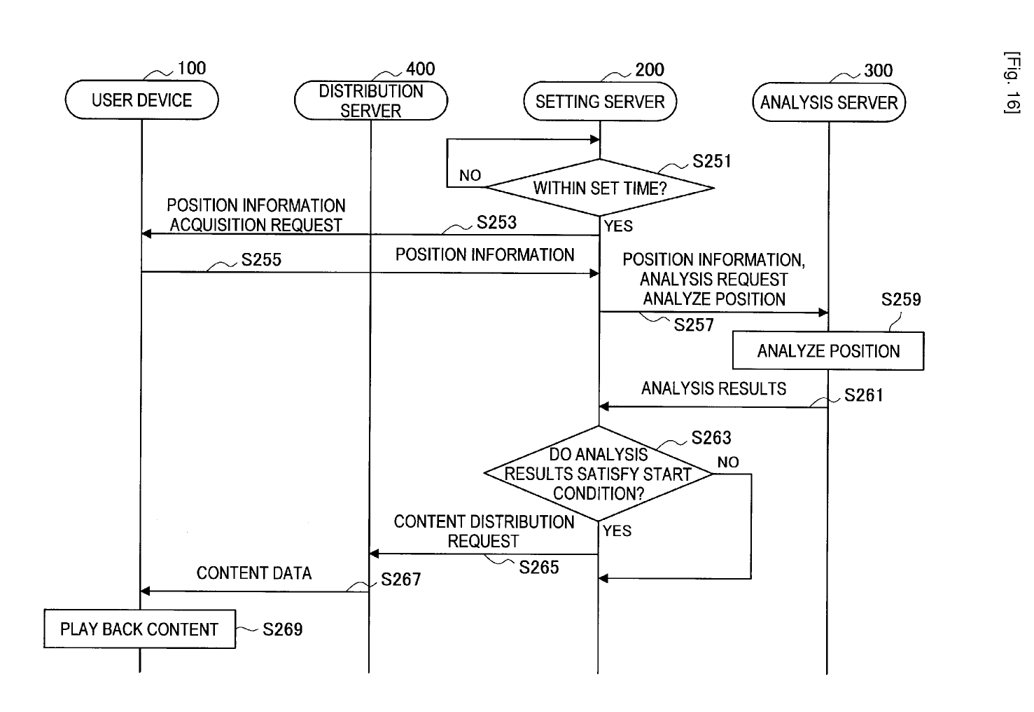

First, the network-distributed public broadcasting system will be explained as the first example with reference to FIGS. 12 to 16. FIG. 12 is an explanatory figure that shows an overview of the network-distributed public broadcasting system that is the first example. FIG. 13 is an explanatory figure that shows an effect of an on-site broadcast distribution system in the first example. FIG. 14 is an explanatory figure that shows an example of the setting description data in the first example. FIG. 15 is a flowchart that shows the operation of the user device 100 in the first example. FIG. 16 is a sequence diagram that shows the operation of the setting system 1 in a modified example of the first example.

Ordinarily, aboard a mode of public transportation such as a train, a bus, an airplane, or the like, an announcement within the vehicle or airplane is provided to the user through a speaker that is installed in the vehicle or airplane. Providing the announcement in the form of audio data that are uploaded to the distribution server 400 makes it possible for the user to listen to the announcement by downloading the audio data to the user device 100. Announcements can also be provided from the distribution server 400 in the same manner for broadcast within a shopping center, a department store, and a museum. The user sets the way that the announcement will be used either in advance or when boarding the train or the like or when entering the shopping center or the like. Aboard the transportation mode or within the location that the user has entered, an alarm sound, a vibration, an icon displayed on a screen, or the like is used to notify the user that an announcement has been made, and the user is able to play back the audio data at a time of the user's choosing. The audio data can be played back repeatedly, of course, and can be heard while other content is being played back or by interrupting the playback of other content, depending on the settings the user makes. Furthermore, the audio data can be acquired even when the user is not aboard a transportation mode or in a shopping center or the like, as long the user is in a location where the user device 100 can be connected to the network.

Hereinafter, the example that is shown in FIG. 12, in which an announcement within a shopping center is distributed from the distribution server 400, will be explained in detail. Assume, for example, that a user U who has the user device 100 has set the operating conditions in advance on the setting screen that the setting server 200 provides. In this example, the operating conditions have been set to indicate that the user will be in a certain shopping center from 7:00 a.m. to 6:00 p.m., that the playback starting up condition is that the distribution of announcements will be accepted except when the user is in a restroom or a restaurant, that the playback volume is set to 5, and that the announcements will be acquired from http://www.bbb.com/announce/.

FIG. 13 is an explanatory figure that shows an effect of an on-site broadcast distribution system in the first example. Referring to FIG. 13, in a case where, for example, the user U in the position indicated by U1, that is, in a restaurant, the distribution of announcements will not be accepted. In a case where the user U thereafter moves to one of the positions indicated by U2 and U3, the distribution of announcements will be accepted. At that time, any announcements that were distributed while the user U was in the U1 position may be distributed as a group once the position information indicates that the user U has moved to a position where distribution can be accepted. If the user U thereafter moves to the U4 position, which is in a restroom, the distribution of the announcements once again is not accepted.

An example of the setting description data for implementing this sort of system is shown in FIG. 14. FIG. 14 is an explanatory figure that shows an example of the setting description data in the first example. When the user inputs the operating conditions described above in advance on the setting screen that the setting server 200 provides, the setting description data that are shown in FIG. 14 are transmitted from the setting server 200. The user device 100 stores the received setting description data and operates in accordance with the operating conditions that are described in the setting description data.

An example of processing by the user device 100 in accordance with the operating conditions that are described in the setting description data is shown in FIG. 15. FIG. 15 is a flowchart that shows the operation of the user device 100 in the first example. The determination portion 135 of the user device 100 first acquires time information from the sensor unit 110 that detects the time, then determines whether the current time is within a set time (Step S201). Specifically, in this case, the determination portion 135 determines whether the current time is between 9:00 a.m. and 6:00 p.m. In a case where the time information is within the set time, the determination portion 135 determines whether the user is within the shopping center that has been set (Step S203). The determination portion 135 then issues a command to the detection information acquisition portion 137 to acquire the position information for the user device 100 from the sensor unit 110 that acquires the position information. The determination portion 135 then determines whether the user is within the shopping center based on the acquired position information. The determination can be made by storing the position information for the shopping center in the user device 100 in advance, for example. Alternatively, results of an analysis by a separate analysis server 300 may be used, the analysis determining whether the position information is within the shopping center, then analyzing whether it is within a restroom and whether it is within a restaurant.

Next, the determination portion 135 whether the user is in one of a restroom and a restaurant, based on the acquired position information (Steps S205, S207). In a case where the user is in a location that is neither a restroom nor a restaurant, the content acquisition portion 131 accesses the distribution server 400 to check whether any content exists that should be played back (Step S209). In a case where content for playback does exist, the content acquisition portion 131 acquires the content for playback, and the playback control portion 130 plays back the content that has been acquired by the content acquisition portion 131 (Step S211). Note that the processing at Steps S201 to S211 may be performed repeatedly, as appropriate. The content that is acquired may also be stored in the storage portion 105. The configuration described here makes it possible for the user to listen to the distributed content repeatedly, as necessary.

An example of an independent type of announcement distribution system has been explained above, but the announcement distribution system may also be implemented as a push type in which the distribution of the content is performed by the setting server 200. An example of the operation of a push type of announcement distribution system is shown in FIG. 16. FIG. 16 is a sequence diagram that shows the operation of the setting system 1 in a modified example of the first example.

In the push type of announcement distribution system that is shown in this example, the operating conditions that have been set in advance based on the handling information from the user device 100 are stored in the setting server 200. The setting server 200 then determines whether the starting up condition has been satisfied, based on the operating conditions. In a case where the starting up condition has been satisfied, the setting server 200 issues a command to the distribution server 400 to distribute content to the user device 100. At this time, the setting server 200 may also use an analysis function of an analysis server 300 to determine whether the starting up condition has been satisfied, based on the detection information that has been acquired from the user device 100.

For example, by referring to the operating conditions, the setting server 200 may determine whether the current time is within a set time period (Step S251). If the current time is within the set time period, the setting server 200 issues a request to the user device 100 to transmit the position information (Step S253). In response to the request, the user device 100 causes the sensor unit 110 to acquire the position information, which is a type of detection information, then transmits the acquired position information to the setting server 200 (Step S255).

The setting server 200 transmits to the analysis server 300 an analysis request that includes analysis conditions and the position information that has been received from the user device 100 (Step S257). In response to the analysis request, the analysis server 300 analyzes the position information (Step S259). For example, if the analysis server 300 receives from the setting server 200 the position information and an analysis request to determine whether the position information is within a specific shopping center and to determine whether the position information is within one of a restroom and a restaurant, the analysis server 300 transmits to the setting server 200, as the analysis results, information as to whether the position information is within the shopping center, whether the position information is within a restroom, and whether the position information is within a restaurant (Step S261). The setting server 200 determines whether the received analysis results satisfy the starting up condition that has been set (Step S263).

In a case where the determination at Step S263 is that the analysis results satisfy the starting up condition, the setting server 200 transmits a content distribution request to the distribution server 400 (Step S265). In response to the received distribution request, the distribution server 400 distributes the content to the user device 100 (Step S267). The user device 100 plays back the received content data (Step S269). Note that, although this is not shown in the drawings, the setting server 200, in addition to transmitting the content distribution request to the distribution server 400, may also transmit playback conditions for the content data to the user device 100, the conditions including the audio volume or the like, for example. Each of the steps described above is performed by the playback control portion 215 of the setting server 200.

In this example, the user device 100 performs the playback processing as soon as the content is distributed, but the present disclosure is not limited to this example. For example, the user device 100 can be set such that when the content is distributed, the user device 100 uses one of a vibration and a screen display to notify the user that the content has been distributed, but the playback of the content is started only when the user performs an operation.

Effect of First Example

According to the network-distributed public broadcasting system that has been described above, an announcement can be heard through a headphone stereo at a time of the user's choosing, even while other content is being played back. Therefore, without any interface with the audio of the content that is being played back, the user does not fail to hear the sound of the announcement. Furthermore, the announcement can be heard even if the user is not in that specific location, so the information can be utilized more widely.

In the example above, a shopping center announcement was described in detail, but in the case of an announcement in a station or on a train, for example, when a train will be delayed, although delay information is often distributed over the Internet these days, it is sometimes not possible to hear an announcement in the station or on the train. An announcement in the station or on the train is more likely to include highly timely information, so it is more useful. Moreover, a person who likes listening to announcements as a hobby, even if they are ordinary announcements, can hear announcements that are distributed over a network.

Furthermore, because the playback conditions can be set individually for each user, it is possible for a hearing-impaired person, for example, to listen to an announcement on headphones at the required volume. In a case where an announcement is provided through a speaker, if the volume of the announcement is set for a hearing-impaired person, many people would probably find it too loud, but that sort of problem is solved by the setting system 1. An announcement may also be provided as both audio data and text data. For example, with the configuration that is described above, a person who has impaired hearing can acquire an announcement or the like on a train in the form of text data instead of audio data. Moreover, if a plurality of audio forms are provided, such as an announcement by a male voice, an announcement by a female voice, an announcement by an animated character, and the like, the user can select the audio data he prefers.

With an announcement that is provided through a speaker, the announcement will sound different depending on whether one is close to or far from the speaker, so differences in audibility will occur. However, in the setting system 1, in which each individual user can listen at the desired settings, so that sort of problem is solved. As long as the user device 100 can be connected to the network, the user can hear announcements under the individually set operating conditions. Particularly in a shopping center or the like, the necessary announcements are not necessarily provided to everyone. If the system is set up such that the content to be heard can be selected based on the type of the announcement, it becomes possible for the user to obtain the desired information more efficiently. It also becomes possible to maintain quiet in a location by decreasing or eliminating broadcasting through a speaker within a vehicle or other location.

### 5. SECOND EXAMPLE

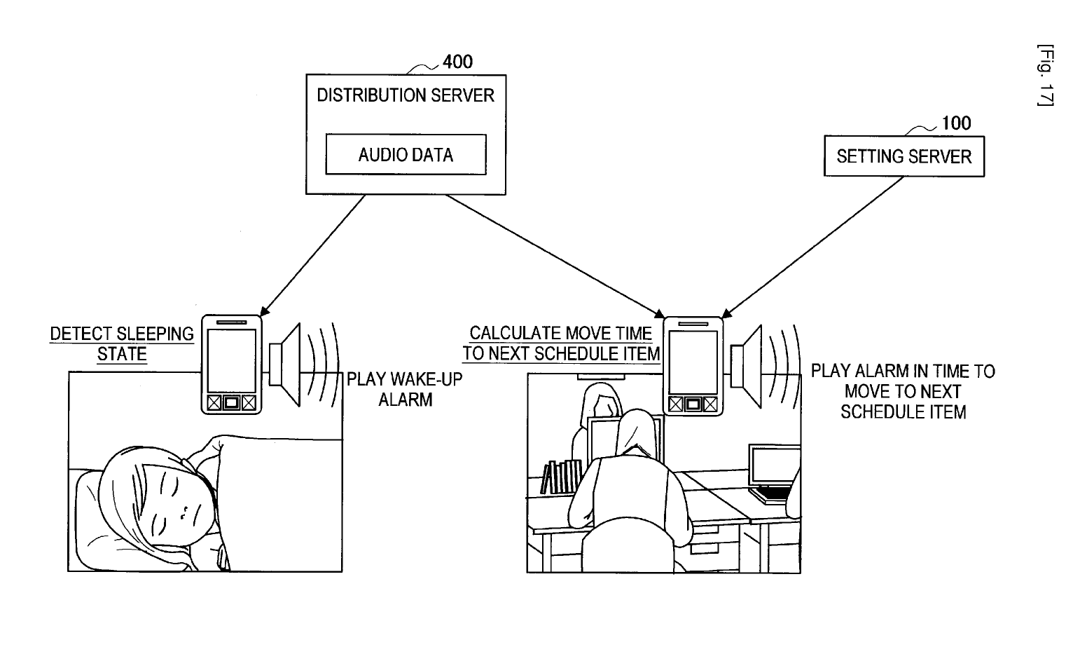

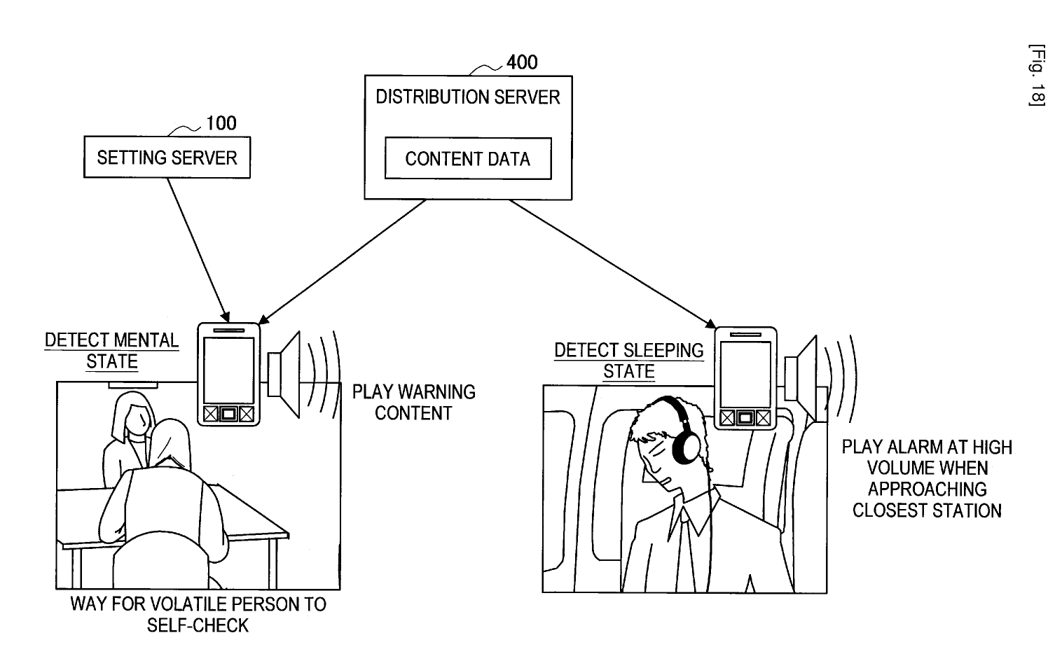

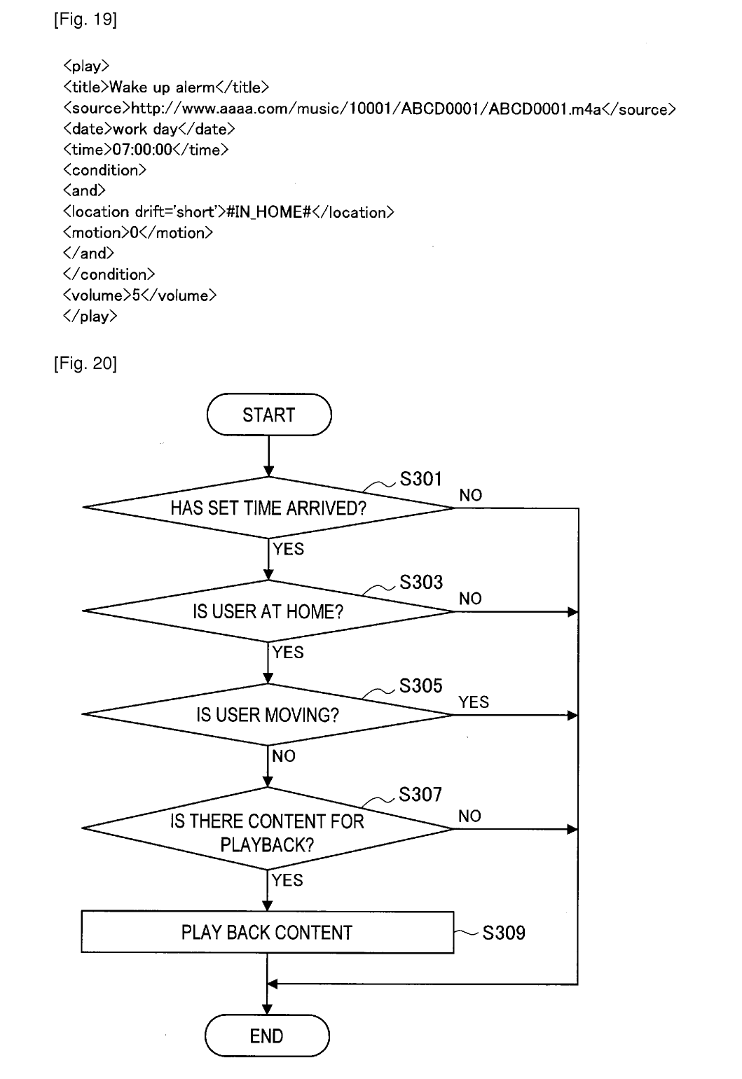

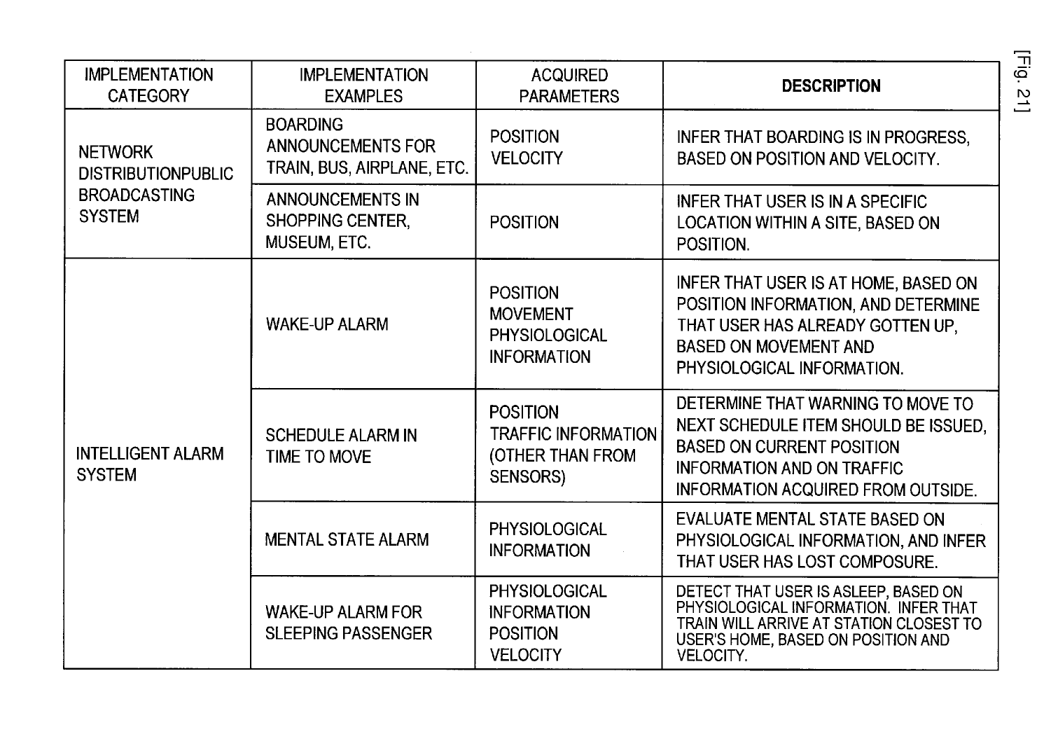

Next, the intelligent alarm system will be explained as the second example with reference to FIGS. 17 to 20. FIG. 17 is an explanatory figure that shows an overview of the intelligent alarm system in the second example. FIG. 18 is an explanatory figure that shows an overview of the intelligent alarm system in the second example. FIG. 19 is an explanatory figure that shows an example of the setting description data in the second example. FIG. 20 is an explanatory figure that shows an example of the operation of the user device 100 in the second example.

An overview of the intelligent alarm system is shown in FIG. 17. The system is an arrangement of alarms whose operation can be flexibly modified in response to the detection information that the user device 100 has acquired. For example, by operating the setting screen that the setting server 200 provides, the user of the user device 100 can modify the conditions for sounding an alarm in response to one of the state of the user and/or the state of the environment surrounding the user. In the case of a wake-up alarm, for example, even though the user has set the alarm, the user might wake up before the alarm sounds, and in that case, it is bothersome for the user to have to perform the operation of shutting off the alarm when the set time arrives. Accordingly, the intelligent alarm system determines whether to sound the alarm not only based on the time, but also based on the user's state.

An alarm can also be sounded in coordination with schedule information. In a typical alarm function that is coordinated with a schedule, the user sets the schedule in advance and sets the conditions for the alarm to sound for each item on the schedule. For example, an alarm can be set to sound ten minutes before a scheduled time. If the setting system 1 according to the present embodiment is used, the setting server 200 can utilize the functions of the analysis server 300, so it check the operating circumstances of the public transportation system and calculate the travel time automatically, then sound the alarm at the optimum time.

Furthermore, as shown in FIG. 18, based on the schedule information, the setting system 1 may also determine the station where the user will disembark, and when the user is approaching the closest station to his destination, the setting system 1 may sound the alarm at a high volume if the user is asleep. The setting system 1 can also acquire physiological information as the detection information, determine the user's mental state, and provide warning content in accordance with the user's mental state.

Next, the example of the wake-up alarm that is shown in FIG. 17 will be explained in detail. The operating conditions that are shown in the setting description data that are shown in FIG. 19 indicate that an alarm will sound at a volume setting of 5 in a case where the user is at home and not moving at 7:00 a.m. on a work day. The setting description data also describe the location where the content that will be played as the alarm is to be acquired.

The user device 100 determines the operating conditions in accordance with the setting description data and sounds the alarm. Specifically, first, the determination portion 135 of the user device 100 determines whether the set time has arrived (Step S301). If the set time has arrived, the determination portion 135 then causes the detection information acquisition portion 137 to acquire the position information and terms whether the user is at home (Step S303). In a case where it is determined that the user is at home, the determination portion 135 then causes the detection information acquisition portion 137 to acquire information that pertains to the user's movement, and the determination portion 135 determines whether the user is moving (Step S305).

In a case where it is determined that the user is not moving, the playback control portion 130 next determines whether the playback content that is described in the setting description data exists (Step S307). The determination at Step S307 is made by determining whether the designated content exists in the distribution server 400 that is described in the setting description data. Prior to accessing the distribution server 400, the playback control portion 130 may also check whether the designated content has been stored in the storage portion 105. In a case where the content has been acquired from the distribution server 400 and stored, the content may be acquired from the storage portion 105. The playback control portion 130 then plays back the acquired content (Step S309).

### 6. CONCLUSION

The setting system 1 according to the present embodiment has been explained above. A plurality of specific examples have been explained, but in all of the examples, the settings that pertain to the operation of the user device 100 can be made online, so even a case where a setting item has changed can be handled easily. For example, even in a case where a sensor unit has been added or a new method of using a detected value has been developed, the setting screen can be updated immediately, without requiring the user to update a separate setting application. In recent years in particular, the trend toward providing individual users with customized information has become stronger, so it is believed that uses will expand further from now on.

Updates to user interfaces are also frequently made on Web pages. A process has therefore come into being in which frequent specification updates are made to make the Web pages easier to use, and the users' opinions and desires with respect to those updates are reflected in further updates. This process can also be applied to the setting screen for setting the operating conditions. In particular, when an attempt is made to provide customized information to every user, there is a tendency for the information that is acquired, the processing of the information, and the operating conditions for using the information to be become more complicated. A process for creating an easy-to-use setting screen would therefore be effective.

It is also desirable for the acquired detection information to be analyzed and utilized in an efficient manner in order for the complex operating conditions to be evaluated. Using an external server to perform this sort of analysis function makes it possible to immediately utilize a function that is made feasible by technological advances.

Note that for the examples that were explained using FIGS. 17 and 18, the parameters that are acquired by the sensor units 110 and the ways in which the acquired parameters are utilized are summarized in the table in FIG. 21. For every function, the user device 100 operates based on complex conditions that are derived from analyses of a plurality of detection information items, but because the functions of the external linked servers 300 are utilized, the functions can be implemented in the user device 100 without having to provide advanced analytical functions in the user device 100 itself.

A preferred embodiment of the present disclosure has been explained in detail above with reference to the attached drawings, but the present disclosure is not limited to this example. It should be understood by those skilled in the art that various modifications, combinations, sub-combinations and alterations may occur depending on design requirements and other factors insofar as they are within the scope of the appended claims or the equivalents thereof.

For example, in the embodiment that is described above, the sensor units 110 are built into the user device 100, but the present disclosure is not limited to this example. For example, information may also be utilized that is acquired by a different device that is associated with the user.

Each of the functions of the linked servers 300 in the embodiment that is described above can also be implemented as functions of the one of the setting server 200 and the user device 100. For example, the function of analyzing the position information may also be implemented in the setting server 200.

The content that is played back in the user device 100 can be treated as a set of concepts that include audio data, image data, games, software, and the like. The audio data would include music, lectures, radio programs, and the like, and the image data would include motion pictures, television programs, video programs, photographs, documents, paintings, diagrams, and the like.

The operating portions of the user device 100 have been explained using the playback portion 103 as an example, but the present disclosure is not limited to this example. For example, operating portions may also be provided for various functions of the user device 100, such as a vibration function, an image capture function, starting up other applications, and the like.

Note that in the present specification, the steps that are described in the flowcharts obviously include processing that is performed sequentially in the sequences described, but the processing does not necessarily have to be performed sequentially and may also be performed in parallel and individually. Even for steps that are performed sequentially, the sequence can obviously be modified as necessary according to the circumstances.

### REFERENCE SIGNS LIST

100 User device
101 Communication portion
102 Control portion
103 Playback portion
104 Output portion
105 Storage portion
106 HANDLING PORTION
110 Sensor unit
120 Setting control portion
130 Playback control portion
131 Content acquisition portion
133 Operating conditions acquisition portion
135 Determination portion
137 Detection information acquisition portion
200 Setting server
201 Communication portion
203 Storage portion
210 Control portion
211 Authentication control portion
213 Setting control portion
215 Playback control portion
300 Linked server
400 Distribution server

1. A user device, comprising:
a communication interface configured to communicate with a server;
a sensor unit configured to detect at least one of a state of a user and a state of the user device; and
a controller configured to control an operating condition of the user device by receiving information from the server based on a comparison between an output of the sensor unit and stored setting description data associating the operating condition with a predetermined output of the sensor unit.

2. The user device of claim 1, further comprising:
a display configured to display a setting screen received from the server, the setting screen configured to receive input setting information associating an operating condition of the user device with an output of the sensor unit.

3. The user device of claim 2, wherein the interface is configured to transmit the input setting information to the server.

4. The user device of claim 3, wherein the interface is configured to receive the setting description data from the server, the setting description data generated by the server based on the input setting information received from the user device.

5. The user device of claim 4, wherein the setting description data includes at least one of setting identifiers identifying operating conditions set based on an output of the sensor unit, and operating conditions set by combining states of information detected by a plurality of sensor units of the user device.

6. The user device of claim 4, wherein the controller is configured to control an operating condition of the user device by comparing an output of the sensor unit to the setting description data.

7. The user device of claim 1, wherein the communication interface is configured to transmit an output of the sensor unit to the server.

8. The user device of claim 7, wherein the controller is configured to control an operating condition of the user device based on operating condition information received from the server.

9. The user device of claim 1, wherein the sensor unit comprises at least one of a vibration sensor, acceleration sensor, velocity sensor, position sensor, direction sensor, environmental sound sensor, temperature sensor, humidity sensor, barometric pressure sensor, image sensor, time sensor, electrical potential sensor, electric current sensor, photoelectricity sensor, an infrared light sensor.

10. A server comprising:
a processor configured to generate a setting screen configured to receive an input associating an operating condition of a user device with a predetermined output of a sensor unit of the user device;
an interface configured to receive input setting information associating the operating condition of the user device with the predetermined output of the sensor unit of the user device, wherein
the processor is configured to generate setting description data associating the operating condition with the predetermined output of the sensor unit based on the input setting information.

11. The server of claim 10, further comprising:
a communication interface configured to transmit the setting screen to the user device.

12. The server of claim 11, wherein the communication interface is configured to receive the input setting information from the user device.

13. The server of claim 10, further comprising:
a communication interface configured to transmit the setting description data to the user device.

14. The server of claim 10, further comprising:
a communication interface configured to receive an output of the sensor unit at the user device, the sensor unit configured to detect at least one of a state of a user and a state of the user device.

15. The server of claim 14, wherein the processor is configured to determine an operating condition of the user device by comparing the received output of the sensor unit to the setting description data.

16. The server of claim 15, wherein the communication interface is configured to transmit information to the user device indicating the operating condition of the user device based on the comparing.

17. The server of claim 14, wherein the communication interface is configured to communicate with at least one of a plurality of linked server configured to process the output of the sensor unit received from the user device.

18. The server of claim 17, wherein the processor is configured to determine an operating condition of the user device based on data received from the at least one of the plurality of linked servers.

19. The server of claim 15, wherein the communication interface is configured to transmit a command to a distribution server based on the determined operating condition, the command causing the distribution server to distribute content to the user device.

20. An operating conditions setting system comprising:
a processor, at a server, configured to generate a setting screen configured to receive input associating an operating condition of a user device with a predetermined output of a sensor unit of the user device;
a first communication interface, at the user device, configured to receive the setting screen from the server;
a user interface, at the user device, configured to display the setting screen and receive input setting information associating an operating condition of the user device with an output of the sensor unit as input setting information;
a second communication interface, at the server, configured to receive the input setting information from the user device; and
a processor, at the server, configured to generate setting description data associating the operating condition with the predetermined output of the sensor unit based on the received input setting information.
